(19) United States
(12) Patent Application Publication
(10) Pub. No.: US 2025/0012485 A1
(43) Pub. Date: Jan. 9, 2025

(54) DUAL GEOTHERMAL PUMPED HYDROPOWER ENERGY SYSTEM USING UNDERGROUND RESERVOIRS OR RETIRED MINES

(71) Applicants: Marc M. Bronzetti, Berkley, MI (US); Michael L. Oristaglio, Newtown, CT (US)

(72) Inventors: Marc M. Bronzetti, Berkley, MI (US); Michael L. Oristaglio, Newtown, CT (US)

(21) Appl. No.: 18/218,351

(22) Filed: Jul. 5, 2023

(51) Int. Cl. F24T 10/30; F03G 4/00; F24T 50/00

(52) U.S. Cl. CPC F24T 10/30; F03G 4/063; F24T 50/00; F24T 2010/56

(57) ABSTRACT

The potential consequences of climate change require the energy sector to swiftly decarbonize and transition to energy sources that do not emit carbon dioxide (CO₂) or other greenhouse gasses (GHG) into the atmosphere. A blended approach of energy sources and distribution should not only be better able to meet these objectives but should also have the ability to provide low cost, low polluting, and scalable solutions which can be tailored for residential, commercial, and industrial applications in the United States and the world. This invention blends two established methods by using an underground reservoir as a continuous source of thermal energy from geothermal heat flow and water storage in a pumped-storage hydroelectric power system. Optional construction and site features can allow a flexible embodiment of this invention to meet specific local needs.

### PRIORITY CLAIM

This application claims priority to U.S. Provisional Patent Application No. 63/368,542 entitled “Dual Geothermal Pumped Hydropower Energy System Using Underground Reservoirs or Retired Mines” to Marc Bronzetti et al. and filed on Jul. 15, 2022.

### TECHNICAL FIELD

This disclosure relates to the generation of sustainable renewable energy in a hybrid or blended system.

### BACKGROUND

The potential consequences of climate change require the energy sector to swiftly decarbonize and transition to energy sources that do not emit carbon dioxide (CO₂) or other greenhouse gasses (GHG) into the atmosphere. To do this in a few decades will require multiple flexible sources of low-carbon energy generation that can be scaled and sited conveniently for specific needs. Today's standard energy industry layout of generation→transmission→distribution may not support a decarbonized energy system that uses low-cost renewable sources to meet GHG objectives. A blended approach of energy sources and distribution should not only be better able to meet these objectives but should also have the ability to provide low cost, low polluting, and scalable solutions which can be tailored for residential, commercial, and industrial applications in the United States and the world.

### BRIEF SUMMARY AND PRIOR ART

Two existing methods of energy generation that produce low CO₂ emissions are geothermal energy systems and pumped-storage hydroelectric (PSH) facilities. Geothermal energy has been around for decades, even centuries, and the applications are too numerous to list here. U.S. Pat. No. 4,443,707 (Scieri, 1984) illustrates the fundamental concept of a PSH facility with upper and lower reservoirs utilizing gravity to flow the upper reservoir fluid down a penstock, through a turbine that generates electricity that is then supplied to the grid. US Patent 2012-0247070 A1 (Payre) expands on a PSH system with details on building and reservoir integration. Further, US Patent 2021-0404435 A1 (Olson) discusses a blended geothermal and PSH system also utilizing external heat sources such as solar arrays. This invention improves upon these two methods using underground reservoirs or flooded mines as a natural, continuous source of thermal energy and storage.

### BRIEF DESCRIPTION OF THE DRAWINGS

For a more complete understanding of the present disclosure, reference is now made to the following description taken in conjunction with the accompanying drawings.

FIG. 1 shows the arrangement of different elements in the invention. Water is pumped out of underground reservoir (1) by means of pumping device (2) and arrives at heat exchanger (3), which is part of a secondary fluid loop (4) in a heating or cooling unit (5), for example, a ground-loop geothermal system using a heat pump. After passing through the heat exchanger, water is then routed to an upper storage reservoir (7) for a pumped-storage hydroelectric facility. Upper reservoir (7) can release water into a penstock (8), feeding a turbine (9) attached to a generator (10) to produce electrical power. The produced power can be used on site or provided to the electrical grid (11). After flowing through the turbine, the water is directed underground back to the lower reservoir (1) in a closed loop.

FIG. 2 shows a second embodiment of the invention. In this case, a second thermal recharge chamber (12) is present in order to restore thermal energy to the fluid if it lacks sufficient temperature as it flows through the penstock from the upper reservoir. This could be a separate reservoir entirely (see FIG. 3), or a segregated portion of the original lower mine reservoir (1). Operational controls for a blend valve (13) would be in place in order to manage storage or flow of the fluid to meet thermal recharge needs against energy demand.

FIG. 3 shows a third embodiment which would be a variant of FIG. 2. In this case, the dual underground chambers are at sufficiently different depths as to allow a penstock installation with accompanying turbine (13). This would allow additional energy generation while transferring fluid from the upper to the lower underground reservoir and maintaining the thermal recharge function of the lower chamber (12).

### DETAILED DESCRIPTION

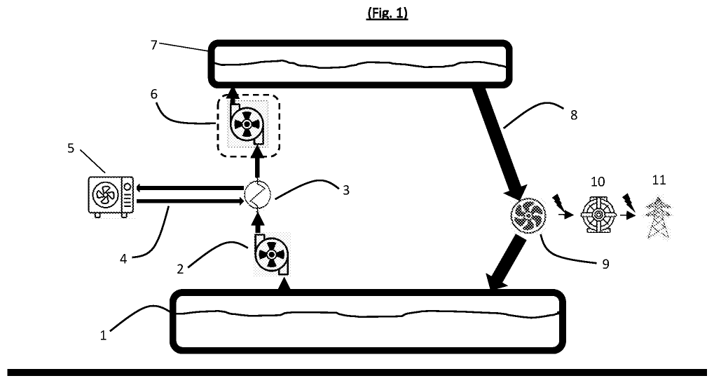

FIG. 1 shows the arrangement of different elements of an embodiment of the invention. Water is pumped out of underground reservoir (1) by means of a pumping device (2) and arrives first at a heat exchanger (3). This exchanger extracts thermal (heat) energy out of the water and transfers the heat energy to a separate, secondary fluid loop (4) where it can serve as a source of heat for local usage (5), for example, in a geothermal system using a heat pump. Specifications for the secondary loop would depend on the attributes of the ground reservoir as well as the specific site needs. After passing through the heat exchanger, water is then routed through an (optional) secondary pump (6) to a storage reservoir (7), which would serve as the upper reservoir in a typical PSH facility. When there is a need for electrical power, upper reservoir (7) would release water into a penstock (8), which feeds a turbine (9) attached to a generator (10) to produce electrical power. The produced power can be used on site or provided to the electrical grid (11). After flowing through the turbine, the water is directed underground back to the underground reservoir (1) in a closed loop.

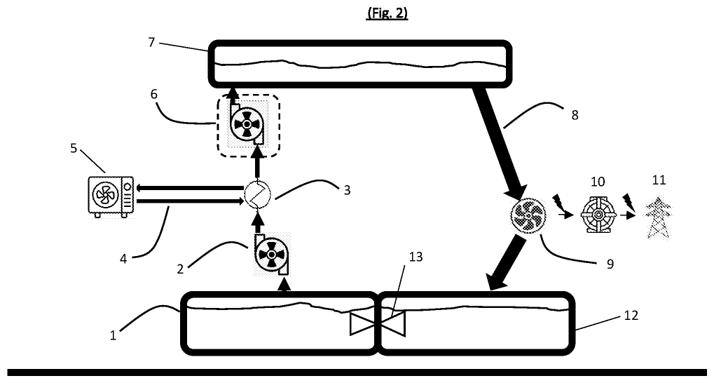

Several details are important to note for any embodiment of this system. The foundation of the invention is the underground reservoir, either constructed specifically for the embodiment or adapted from an existing facility such as an abandoned mine. Properties of the underground reservoir must be such that it has sufficient storage capacity to support the volumes of water needed to meet the specifications of the subsystems for thermal energy transfer and/or for PSH power generation. To maximize the potential for both thermal and mechanical energy extraction, the lower reservoir would typically consist of two compartments: a compartment in which water is held in a state (e.g., at the desired temperature) in which it can be used immediately for both thermal and mechanical energy transfer and a second compartment in which the thermal energy content of the water can be recharged by natural geothermal heat flow (FIG. 2).

Additionally, the well and pumping system which extracts the fluid out of the reservoir must be such as both to ensure efficient operation and to avoid the possibility of ground water contamination. Control units to monitor the well for leaks and to recharge the reservoir when needed could be part of an embodiment.

The optional secondary pump (6) in FIG. 1 allows pumping of water to higher elevation to increase the head of the PSH system. Inclusion of this component would depend on site conditions favoring higher elevation of the upper reservoir.

An embodiment of the system can be constructed with appropriate bypass equipment and/or control functionality, allowing it to adjust to energy needs on demand. For example, the heat exchange loop can be disabled, with the system ran purely as a PSH unit. Conversely, the pumped fluid could be used in the geothermal subsystem only, returning the fluid directly to the underground reservoir if, for example, the upper reservoir is full or closed for maintenance or repairs, or if power from the turbine is not required.

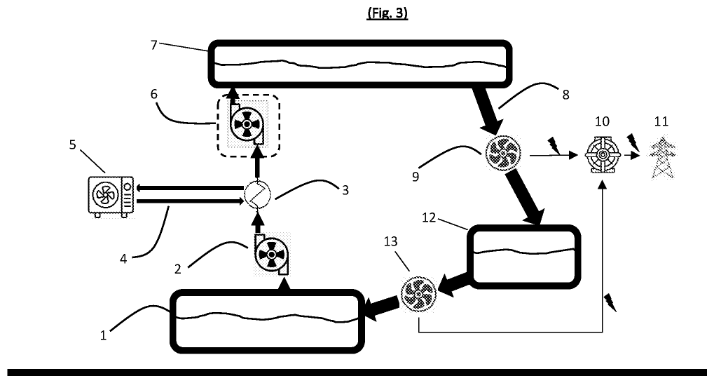

FIG. 3 shows an additional embodiment of the underground concept. If space is available and additional energy generation needed, the underground chambers can be separate and at a sufficient difference in depth to provide a secondary penstock and turbine (13) with which to generate power when transferring fluid from the return reservoir (12) back to the starting reservoir (1). Optional controls could be installed to bypass when necessary to offer the most flexibility to site operations and off taker demand.

To summarize, this invention relates to the implementation of two established energy production methods in a single system using an underground water reservoir—either constructed specifically or adapted from a site already available, such as an abandoned mine—for both thermal energy in a geothermal system and mechanical energy in a pumped-storage hydroelectric system.

A full embodiment of the model requires:
(a) Specification of the lower underground reservoir (1)
(b) Specification of the pump (2)
(c) Specification of the heat exchanger (3)
(d) Specification of the secondary fluid loop and related components (4)
(e) Specification of the heat pump (5)
(f) Specification of the optional secondary fluid pump (6)
(g) Specification of the upper storage reservoir (7)
(h) Specification of the penstock (8)
(i) Specification of the turbine (9)
(j) Specification of the generator (10)

What is claimed is:

1. A method for operating an underground source of water as both a heat reservoir for geothermal heating and cooling applications and as the lower storage reservoir in a pumped-storage hydroelectric (PSH) facility.

2. The method of claim 1 in which the underground reservoir is divided into two compartments: a compartment in which water is in a state (e.g., at the desired temperature) in which it can be used immediately for both thermal and mechanical energy transfer and a second compartment in which the thermal energy content of the water can be recharged by natural geothermal heat flow.

3. The method of claim 1 in which the PSH facility contains two pumping units: one unit for pumping water from the underground reservoir to the level of the thermal exchange system and a second unit for pumping water, after it has exited the thermal exchange system, to an upper reservoir of the PSH facility located at a higher elevation than the thermal exchange system.

4. The method of claim 1 in which the system has appropriate bypass equipment and/or control functionality, allowing it to adjust to energy needs on demand by operating solely as a heat exchange system coupled to a geothermal heating or cooling system or solely as a PSH power facility or as both.
